(19) United States
(12) Patent Application Publication
(10) Pub. No.: US 2024/0244502 A1
(43) Pub. Date: Jul. 18, 2024

(54) METHOD AND APPARATUS FOR SELECTING ROUTE SELECTION DESCRIPTOR IN WIRELESS NETWORK

(71) Applicant: SAMSUNG ELECTRONICS CO., LTD., Suwon-si, Gyeonggi-do (KR)

(72) Inventors: Lalith KUMAR, Bangalore (IN); Hoyeon LEE, Suwon-si (KR); Arijit SEN, Bangalore (IN); Koustav ROY, Bangalore (IN); Varini GUPTA, Bangalore (IN)

(21) Appl. No.: 18/562,176

(22) PCT Filed: May 13, 2022
(86) PCT No.: PCT/KR2022/006874

§ 371 Date: Nov. 17, 2023

(30) Foreign Application Priority Data
May 17, 2021 (IN) 202141022146
Apr. 26, 2022 (IN) 202141022146

(51) Int. Cl. H04W 40/02; H04L 45/302; H04W 40/24; H04W 76/10

(52) U.S. Cl. CPC H04W 40/02; H04L 45/306; H04W 40/24; H04W 76/10

(57) ABSTRACT

The disclosure relates to a 5G or 6G communication system for supporting a higher data transmission rate. Embodiments herein provide a method for selecting route selection descriptor in network (1000) by a CE (100). The method includes receiving a URSP rule configuration from HPLMN apparatus (200). The URSP rule configuration includes a route selection criteria in a block. The block can be, for example, but not limited to a URSP information block of the URSP rule configuration, a traffic descriptor block of the URSP rule configuration, a route selection descriptor block of the URSP rule configuration, and a route validation criteria block of the URSP rule configuration. Further, the method includes detecting an initiation of an application in the UE. Further, the method includes determining that the URSP rule configuration is applicable to the application. Further, the method includes selecting the route selection descriptor included in the URSP rule configuration in response to determining that the URSP rule configuration is applicable to the application.

### TECHNICAL FIELD

The present invention relates to a wireless network, and more specifically related to systems and methods for selecting a route selection descriptor in the wireless network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

The present disclosure provides a method, a UE and a HPLMN apparatus for selecting a route selection descriptor in a wireless network.

### Technical Solution

According to an aspect of an exemplary embodiment, there is provided a communication method in a wireless communication.

### Advantageous Effects

Aspects of the present disclosure provide efficient communication methods in a wireless communication system.

### DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1 is a schematic view illustrating a scenario where a UE is connected to different PLMN with each access type, according to the prior arts;

FIG. 2a illustrates an overview of a wireless network for selecting a route selection descriptor, according to the embodiments as disclosed herein;

FIG. 2b shows various hardware components of a UE, according to embodiments as disclosed herein;

FIG. 2c shows various hardware components of a HPLMN apparatus, according to embodiments as disclosed herein;

FIG. 3 is a flow chart illustrating a method, implemented by the UE, for selecting the route selection descriptor in the wireless network, according to the embodiments as disclosed herein; and

FIG. 4 is a flow chart illustrating a method, implemented by the HPLMN apparatus, for selecting the route selection descriptor in the wireless network, according to the embodiments as disclosed herein.

FIG. 5 illustrates the configuration of a UE in a wireless communication system according to various embodiments.

FIG. 6 illustrates the configuration of a base station or a network entity in a wireless communication system according to various embodiments.

### BEST MODEL

Accordingly, the embodiment herein is to provide a method for selecting a route selection descriptor in a wireless network. The method includes receiving, by a UE in the wireless network, a URSP rule configuration from a Home Public Land Mobile Network (HPLMN) apparatus in the wireless network. The URSP rule configuration includes a route selection criteria in a block. The block is at least one of a URSP information block of the URSP rule configuration, a traffic descriptor block of the URSP rule configuration, a route selection descriptor block of the URSP rule configuration, and a route validation criteria block of the URSP rule configuration. The route selection criteria comprise one of a PLMN identifier (ID), a Mobile Country Code (MCC), a Radio Access Technology (RAT) identifier and a Non-3^{rd} Generation Partnership Project (Non-3GPP) access trusted or non-3GPP access untrusted. Further, the method includes detecting, by the UE, an initiation of an application in the UE. Further, the method includes determining, by the UE, that the URSP rule configuration is applicable to the application. Further, the method includes selecting, by the UE, the route selection descriptor included in the URSP rule configuration in response to determining that the URSP rule configuration is applicable to the application.

In an embodiment, selecting, by the UE, the route selection descriptor included in the URSP rule configuration includes determining, by the UE, the block matching the route selection criteria in the URSP rule configuration, selecting, by the UE, the at least one block based on the route selection criteria, and selecting, by the UE, the route selection descriptor based on the at least one of the selected block.

Accordingly, the embodiment herein is to provide a method for selecting a route selection descriptor in a wireless network. The method includes creating, by a HPLMN apparatus in the wireless network, a URSP rule configuration comprising a route selection descriptor in a block. The block is at least one of a URSP information block of the URSP rule configuration, a traffic descriptor block of the URSP rule configuration, a route descriptor block of the URSP rule configuration, and a route validation criteria field of the URSP rule configuration. The route selection criteria include one of a PLMN identifier (ID), a Mobile Country Code (MCC), a RAT identifier and a N3GPP access. Further, the method includes sending, the HPLMN apparatus, the URSP rule configuration to the UE in the wireless network for controlling the service initiation based on the route selection descriptor included in the URSP rule configuration. The service comprises one of a Protocol Data Unit (PDU) session service, a Slice ID service, a Session and Service Continuity (SSC) Type service, a PDU session type service and a PDU session access type service.

Accordingly, the embodiment herein is to provide a UE for selecting a route selection descriptor in a wireless network. The UE includes a service initiation controller coupled to a memory and a processor. The service initiation controller is configured to receive a URSP rule configuration from a HPLMN apparatus in the wireless network. The URSP rule configuration includes a route selection criteria in a block. The block is at least one of a URSP information block of the URSP rule configuration, a traffic descriptor block of the URSP rule configuration, a route selection descriptor block of the URSP rule configuration, and a route validation criteria block of the URSP rule configuration. The route selection criteria include one of a PLMN ID, a MCC, a RAT identifier and a Non-3GPP access trusted or non-3GPP access untrusted. Further, the service initiation controller is configured to detect an initiation of an application in the UE. Further, the service initiation controller is configured to determine that the URSP rule configuration is applicable to the application. Further, the service initiation controller is configured to select the route selection descriptor included in the URSP rule configuration in response to determining that the URSP rule configuration is applicable to the application.

Accordingly, the embodiment herein is to provide a HPLMN apparatus for selecting a route selection descriptor in a wireless network. The HPLMN apparatus includes a service initiation controller coupled to a memory and a processor. The service initiation controller is configured to create a URSP rule configuration comprising a route selection descriptor in a block. The block is at least one of a URSP information block of the URSP rule configuration, a traffic descriptor block of the URSP rule configuration, a route descriptor block of the URSP rule configuration, and a route validation criteria field of the URSP rule configuration. The route selection criteria comprise one of a PLMN ID, an MCC, a RAT identifier and a N3GPP access. The service initiation controller is configured to send the URSP rule configuration to the UE in the wireless network for controlling the service initiation based on the route selection descriptor included in the URSP rule configuration, wherein the service comprises one of a PDU session service, a Slice ID service, a SSC Type service, a PDU session type service and a PDU session access type service.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### MODE FOR INVENTION

This application is based on and derives the benefit of Indian Provisional Application 202141022146 filed on 17 May 2021, the contents of which are incorporated herein by reference.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

In general, in a wireless communication network, there is single subscription of a User Equipment (UE). The UE registers with different Public Land Mobile Network (PLMNs) over a 3GPPA and N3GPPA. i.e. let's say PLMN-1 over 3GPPA (3GPP access) and PLMN-2 over N3GPPA (non-3GPP access) at time-x. The UE registers with different PLMNs over the 3GPPA and the N3GPPA. i.e. let's say PLMN-3 over the 3GPPA and a PLMN-2 over the N3GPPA at time-y.

Based on roaming agreement, a Slice-1 over PLMN-2 (N3GPPA) at time-x may be is a preferred option as the PLMN-1 is costly roaming partner of a Home Public Land Mobile Network (HPLMN) comparatively. But at time-y, a PLMN-3 (over 3GPPA) may be preferred because the PLMN-2 is costly roaming partner comparatively (i.e., same protocol Data Unit (PDU) session or slice establishment can vary between PLMN IDs based on which PLMN ID UE is registered on the alternative Radio Access Technology (RAT)).

Thus there is a need for better HPLMN control. Also, there is a need for the mechanism in which the UE can be configured by the HPLMN. So that, the UE can make a decision as to on which PLMN a given service like slice, PDU session etc UE should initiate.

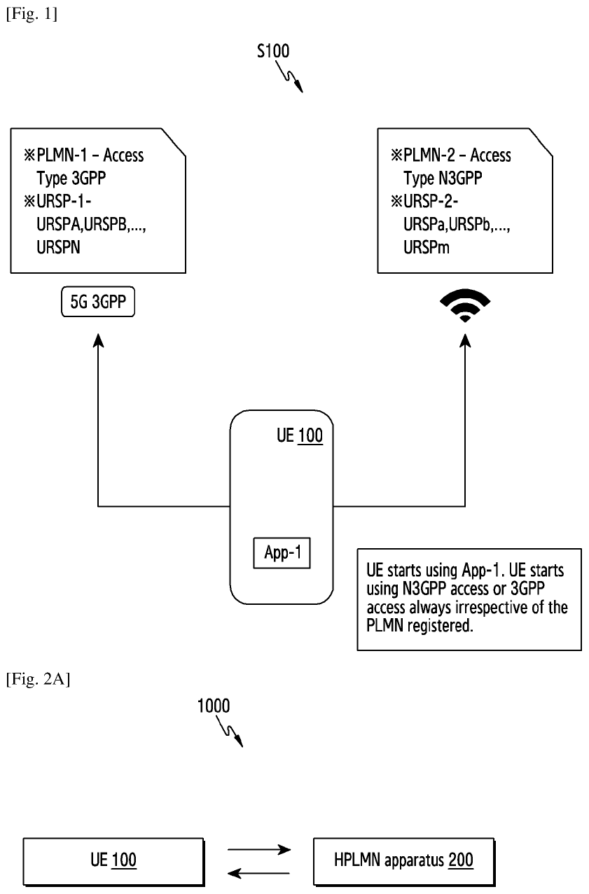

FIG. 1 is a schematic view illustrating a scenario (S100) where a UE (100) is connected to different PLMN with each access type, according to the prior arts. Referring to the FIG. 1 consider a conventional methods and systems, if application 1 (i.e., App-1) is configured to initiate a service over non-3GPP access type. Irrespective of the PLMN, the UE (100) registers over non 3GPP access type, the UE (100) will always initiate the service of App-1 over a non-3GPP access type. Thus there is a need of a mechanism to configure in the UE (100) which can guide the UE (100) to initiate a given service (Slice or PDU session etc) over a given access based on the PLMN, the UE (100) is registered on that access after taking into account the PLMN registers on a second access.

Thus, it is desired to address the above mentioned disadvantages or other shortcomings or at least provide a useful alternative.

The principal object of the embodiments herein is to provide a method, a UE and a HPLMN apparatus for selecting a route selection descriptor in a wireless network.

Another object of the embodiments herein is to maintain User Equipment Route Selection Policy (URSP) rules per Public Land Mobile Network (PLMN) for each access types.

Accordingly, the embodiment herein is to provide a method for selecting a route selection descriptor in a wireless network. The method includes receiving, by a UE in the wireless network, a URSP rule configuration from a HPLMN apparatus in the wireless network. The URSP rule configuration includes a route selection criteria in a block. The block is at least one of a URSP information block of the URSP rule configuration, a traffic descriptor block of the URSP rule configuration, a route selection descriptor block of the URSP rule configuration, and a route validation criteria block of the URSP rule configuration. The route selection criteria comprise one of a PLMN ID, an MCC, a RAT identifier and a Non-3rd Generation Partnership Project (Non-3GPP) access trusted or non-3GPP access untrusted. Further, the method includes detecting, by the UE, an initiation of an application in the UE. Further, the method includes determining, by the UE, that the URSP rule configuration is applicable to the application. Further, the method includes selecting, by the UE, the route selection descriptor included in the URSP rule configuration in response to determining that the URSP rule configuration is applicable to the application.

The proposed method can be used to maintain the URSP rules per PLMN for each access types. The URSP rules consists of the route selection criteria in each of the blocks when the match is achieved to the parameters configured in route selection criteria of each block then the respective block is selected after successful selection of blocks appropriate Route selection descriptor (RSD) is selected to decide on the parameters to be used while establishing the PDU session. Due to this flexibility HPLMN can configure the RSD per PLMN, per MCC (country), per Access type (trusted or untrusted), per RAT. For example the HPLMN can configure the UE to establish the PDU session over 3GPP access in one PLMN ID or in one particular country whereas same PDU session can be established on another access like non-3GPP access on another PLMN ID or another country etc. Providing business flexibility to the operator and UE can also receive services appropriately.

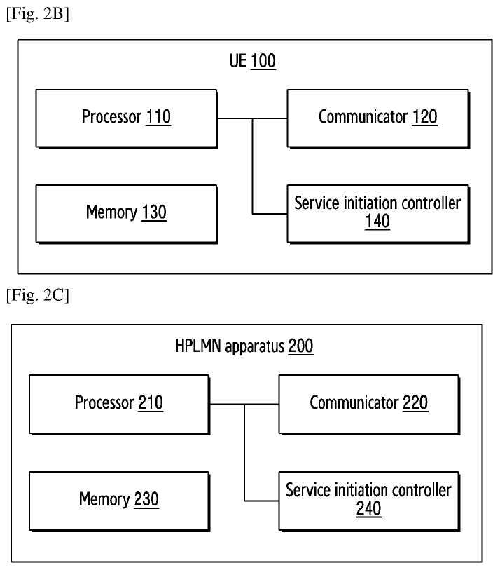

Referring now to the drawings and more particularly to FIGS. 2 through 4, where similar reference characters denote corresponding features consistently throughout the figures, there are shown preferred embodiments.

FIG. 2a illustrates an overview of a wireless network (1000) for selecting a route selection descriptor, according to the embodiments as disclosed herein. In an embodiment, the wireless network (1000) includes the UE (100) and a HPLMN apparatus (200). The wireless network (1000) can be, for example, but not limited to a 4G network, a 5G network, a 6G network, an ORAN network or the like. The UE (100) can be, for example, but not limited to a laptop, a desktop computer, a notebook, a relay device, a Device-to-Device (D2D) device, a vehicle to everything (V2X) device, a smartphone, a tablet, an immersive device, and an internet of things (IOT) device.

The HPLMN apparatus (200) creates a URSP rule configuration comprising a route selection descriptor in a block. The block can be, for example, but not limited to a URSP information block of the URSP rule configuration, a traffic descriptor block of the URSP rule configuration, a route descriptor block of the URSP rule configuration, and a route validation criteria field of the URSP rule configuration. The route selection criteria can be, for example, but not limited to a PLMN ID, a mobile country code (MCC) or directly indicate a country (i.e. there are some countries which are represented by multiple MCCes), a RAT identifier and a N3GPP access. Further, the HPLMN apparatus (200) sends the URSP rule configuration to the UE (100) for controlling the service initiation based on the route selection descriptor included in the URSP rule configuration. The route selection descriptor parameters can be, for example, but not limited to a PDU session service, a Slice ID service, a SSC Type service, a PDU session type service and a PDU session access type service which will be used to establish a PDU session.

The UE (100) receives the URSP rule configuration from the HPLMN apparatus (200) and detects an initiation of an application in the UE (100). Further, the UE (100) determines that the URSP rule configuration is applicable to the application and the block matching the route selection criteria in the URSP rule configuration. Based on the route selection criteria, the UE (100) selects the block and the route selection descriptor based on the selected block.

Table 1 illustrates new information in a USRP information block.

TABLE 1

| | | | PCF | |
|---|---|---|---|---|
| | | | permitted | |
| Information | | | to modify | |
| name | Description | Category | in a URSP | Scope |
| URSP rules | 1 or more | Mandatory | Yes | UE |
| | URSP rules | | | context |
| New | New | Mandatory | Yes | UE |
| Information | Information | | | context |
| | can be one of | | | |
| | PLMN-ID or | | | |
| | MCC(mobile | | | |
| | country code) | | | |
| | or RAT or | | | |
| | N3GPPA | | | |
| | Trusted/Untrusted | | | |
| Traffic | This part | Mandatory | | |
| descriptor | defines the | | | |
| | Traffic | | | |
| | descriptor | | | |
| | components for | | | |
| | the URSP rule. | | | |
| Application | It consists of | Optional | Yes | UE |
| descriptors | OSId and | | | context |
| | OSAppId(s). | | | |
| IP descriptors | Destination IP 3 | Optional | Yes | UE |
| | tuple(s) (IP | | | context |
| | address or IPv6 | | | |
| | network prefix, | | | |
| | port number, | | | |
| | protocol ID of | | | |
| | the protocol | | | |
| | above IP). | | | |
| Domain | Destination | Optional | Yes | UE |
| descriptors | FQDN(s) or a | | | context |
| | regular | | | |
| | expression as a | | | |
| | domain name | | | |
| | matching | | | |
| | criteria. | | | |
| Non-IP | Descriptor(s) | Optional | Yes | UE |
| descriptors | for destination | | | context |
| | information of | | | |
| | non-IP traffic | | | |
| DNN | This is matched | Optional | Yes | UE |
| | against the | | | context |
| | DNN | | | |
| | information | | | |
| | provided by the | | | |
| | application. | | | |
| Connection | This is matched | Optional | Yes | UE |
| Capabilities | against the | | | context |
| | information | | | |
| | provided by a | | | |
| | UE application | | | |
| | when it requests | | | |
| | a network | | | |
| | connection with | | | |
| | certain | | | |
| | capabilities. | | | |
| List of Route | A list of Route | Mandatory | | |
| Selection | Selection | | | |
| Descriptors | Descriptors. | | | |
| | The | | | |
| | components of | | | |
| | a Route | | | |
| | Selection | | | |
| | Descriptor. | | | |

Referring to the table 1, The proposed method introduces a new information in the URSP rule structure based on which Protocol Data Unit (PDU) session/slice will be decided to be routed to cither 3GPPA/N3GPPA per PLMN. The new information can be one of PLMN id or Mobile Country Code (MCC) or Radio Access Technology (RAT) or N3GPP access (Trusted/Untrusted). This new information will enable the UE to decide which URSP rule to prioritise, if the UE (100) is connected across different PLMNs per access types or different RATs or inside a location (e.g. MCC).

When this new information is configured the corresponding URSP rule with respect to the traffic descriptor and the route selection descriptor are applicable (i.e. selected), only if the UE (100) is registered on respective PLMN ID (or if the UE (100) has selected the respective PLMN ID/SNPN ID during PLMN selection procedure) or the UE (100) is in respective configured country (represented by mobile country code) or Radio access technology (RAT) or based on trusted/untrusted non 3GPP access type. In yet another embodiment, when this new information is configured the corresponding URSP rule with respect to the traffic descriptor and the route selection descriptor are applicable (i.e. selected), only if the UE (100) is registered on respective PLMN ID (or if the UE (100) has selected the respective PLMN ID/SNPN ID during PLMN selection procedure) AND the UE (100) is in respective configured country (represented by mobile country code) AND Radio access technology (RAT) AND based on trusted/untrusted non 3GPP access type.

Below table 2 illustrates new information in traffic descriptor block.

TABLE 2

| | | | PCF | |
|---|---|---|---|---|
| | | | permitted | |
| Information | | | to modify | |
| name | Description | Category | in a URSP | Scope |
| URSP rules | 1 or more | Mandatory | Yes | UE context |
| | URSP rules | | | |
| Information | Description | Category | PCF | Scope |
| name | | | permitted | |
| | | | to modify | |
| | | | in a UE | |
| | | | context | |
| Rule | Determines the | Mandatory | Yes | UE context |
| Precedence | order the URSP | | | |
| | rule is enforced | | | |
| | in the UE. | | | |
| Traffic | This part | Mandatory | | |
| descriptor | defines the | | | |
| | Traffic | | | |
| | descriptor | | | |
| | components for | | | |
| | the URSP rule. | | | |
| New | New | Mandatory | Yes | UE context |
| Information | Information | | | |
| | can be one of | | | |
| | PLMN-ID or | | | |
| | MCC(mobile | | | |
| | country code) | | | |
| | or RAT or | | | |
| | N3GPPA | | | |
| | Trusted/Untrusted | | | |
| Application | It consists of | Optional | Yes | UE context |
| descriptors | OSId and | | | |
| | OSAppId(s). | | | |
| IP descriptors | Destination IP 3 | Optional | Yes | UE context |
| | tuple(s) (IP | | | |
| | address or IPv6 | | | |
| | network prefix, | | | |
| | port number, | | | |
| | protocol ID of | | | |
| | the protocol | | | |
| | above IP). | | | |
| Domain | Destination | Optional | Yes | UE context |
| descriptors | FQDN(s) or a | | | |
| | regular | | | |
| | expression as a | | | |
| | domain name | | | |
| | matching | | | |
| | criteria. | | | |
| Non-IP | Descriptor(s) | Optional | Yes | UE context |
| descriptors | for destination | | | |
| | information of | | | |
| | non-IP traffic | | | |
| DNN | This is matched | Optional | Yes | UE context |
| | against the | | | |
| | DNN | | | |
| | information | | | |
| | provided by the | | | |
| | application. | | | |
| Connection | This is matched | Optional | Yes | UE context |
| Capabilities | against the | | | |
| | information | | | |
| | provided by a | | | |
| | UE application | | | |
| | when it requests | | | |
| | a network | | | |
| | connection with | | | |
| | certain | | | |
| | capabilities. | | | |
| List of Route | A list of Route | Mandatory | | |
| Selection | Selection | | | |
| Descriptors | Descriptors. | | | |
| | The | | | |
| | components of | | | |
| | a Route | | | |
| | Selection | | | |
| | Descriptor are | | | |
| | described in | | | |
| | table 6.6.2.1-3. | | | |

Referring to the table 2, the proposed method introduces new information in traffic descriptor block based on which PDU session/Slice will be decided to be routed to either 3GPPA/N3GPPA per PLMN. The new information can be one of PLMN id or MCC (Mobile Country Code) or RAT or N3GPP access (Trusted/Untrusted). This new information will enable the UE (100) to decide which URSP rule to prioritise, if the UE (100) is connected across different PLMNs per access types or different RATs or inside a location (e.g. MCC).

The network can define priority among Traffic descriptor per PLMN-ID. When this new information is configured the corresponding Traffic descriptor block is applicable, only if the UE (100) is registered on respective PLMN ID (or if the UE (100) has selected the respective PLMN ID/SNPN ID during PLMN selection procedure) or the UE (100) is in respective configured country (represented by mobile country code) or Radio access technology (RAT) or based on trusted/untrusted non 3GPP access type. In yet another embodiment, the network can define priority among Traffic descriptor per PLMN-ID. When this new information is configured the corresponding Traffic descriptor block is applicable, only if the UE (100) is registered on respective PLMN ID (or if the UE (100) has selected the respective PLMN ID/SNPN ID during PLMN selection procedure) and the UE (100) is in respective configured country (represented by mobile country code) and Radio access technology (RAT) and based on trusted/untrusted non 3GPP access type.

Below table 3 illustrates new information in route selection descriptor block.

TABLE 3

| | | | PCF | |
|---|---|---|---|---|
| | | | permitted | |
| Information | | | to modify | |
| name | Description | Category | in a URSP | Scope |
| Route | Determines the | Mandatory | Yes | UE |
| Selection | order in which | | | context |
| Descriptor | the Route | | | |
| Precedence | Selection | | | |
| | Descriptors are | | | |
| | to be applied. | | | |
| New | New | Mandatory | Yes | UE |
| Information | Information | | | context |
| | can be one of | | | |
| | PLMN-ID or | | | |
| | MCC(mobile | | | |
| | country code) | | | |
| | or RAT or | | | |
| | N3GPPA | | | |
| | Trusted/Untrusted | | | |
| Route | This part | Mandatory | | |
| selection | defines the | | | |
| components | route selection | | | |
| | components | | | |
| SSC Mode | One single | Optional | Yes | UE |
| Selection | value of SSC | | | context |
| | mode. | | | |
| Network Slice | Either a single | Optional | Yes | UE |
| Selection | value or a list of | | | context |
| | values of S- | | | |
| | NSSAI(s). | | | |
| DNN | Either a single | Optional | Yes | UE |
| Selection | value or a list of | | | context |
| | values of | | | |
| | DNN(s). | | | |
| PDU Session | One single | Optional | Yes | UE |
| Type Selection | value of PDU | | | context |
| | Session Type | | | |
| Non-Seamless | Indicates if the | Optional | Yes | UE |
| Offload | traffic of the | | | context |
| indication | matching | | | |
| | application is to | | | |
| | be offloaded to | | | |
| | non-3GPP | | | |
| | access outside | | | |
| | of a PDU | | | |
| | Session. | | | |
| Access Type | Indicates the | Optional | Yes | UE |
| preference | preferred | | | context |
| | Access Type | | | |
| | (3GPP or non- | | | |
| | 3GPP or Multi- | | | |
| | Access) when | | | |
| | the UE | | | |
| | establishes a | | | |
| | PDU Session | | | |
| | for the | | | |
| | matching | | | |
| | application. | | | |
| Route | This part | Optional | | |
| Selection | defines the | | | |
| Validation | Route | | | |
| Criteria | Validation | | | |
| | Criteria | | | |
| | components | | | |
| Time Window | The time | Optional | Yes | UE |
| | window when | | | context |
| | the matching | | | |
| | traffic is | | | |
| | allowed. The | | | |
| | RSD is not | | | |
| | considered to | | | |
| | be valid if the | | | |
| | current time is | | | |
| | not in the time | | | |
| | window. | | | |
| Location | The UE | Optional | Yes | UE |
| Criteria | location where | | | context |
| | the matching | | | |
| | traffic is | | | |
| | allowed. The | | | |
| | RSD rule is not | | | |
| | considered to | | | |
| | be valid if the | | | |
| | UE location | | | |
| | does not match | | | |
| | the location | | | |
| | criteria. | | | |

Referring to the table 3, the proposed method introduces new information in route selection descriptor block based on which the PDU session will be decided to be routed to either 3GPPA/N3GPPA per PLMN. The new information can be one of PLMN id or MCC (Mobile Country Code) or RAT or N3GPP access (Trusted/Untrusted). This new information will enable the UE (100) to decide which URSP rule to prioritise, if the UE (100) is connected across different PLMNs per access types or different RATs or inside a location (e.g. MCC).

The network can define priority among route selection descriptor policy per PLMN-ID. When this new information is configured the corresponding Route selection descriptor(s) are applicable, only if the UE (100) is registered on respective PLMN ID/SNPN ID or if the UE (100) has selected the respective PLMN ID/SNPN ID during PLMN selection procedure or the UE (100) is in the respective configured country (represented by mobile country code) or Radio access technology (RAT) or based on trusted/untrusted non 3GPP access type. In yet another embodiment, when this new information is configured the corresponding Route selection descriptor(s) are applicable, only if the UE (100) is registered on respective PLMN ID (or if the UE has selected the respective PLMN ID/SNPN ID during PLMN selection procedure) and the UE (100) is in the respective configured country (represented by mobile country code) and Radio access technology (RAT) or based on trusted/untrusted non 3GPP access type.

In yet another embodiment, if the respective RSD is selected then the UE (100) can select the PLMN-ID as configured in the selected route selection descriptor (RSD)

Table 4 illustrates new information in route validation criteria block of the URSP rule configuration.

TABLE 4

| | | | PCF | |
|---|---|---|---|---|
| | | | permitted | |
| Information | | | to modify | |
| name | Description | Category | in a URSP | Scope |
| Route | Determines the | Mandatory | Yes | UE context |
| Selection | order in which | | | |
| Descriptor | the Route | | | |
| Precedence | Selection | | | |
| | Descriptors are | | | |
| | to be applied. | | | |
| Route | This part | Mandatory | | |
| selection | defines the | | | |
| components | route selection | | | |
| | components | | | |
| SSC Mode | One single | Optional | Yes | UE context |
| Selection | value of SSC | | | |
| | mode. | | | |
| Network Slice | Either a single | Optional | Yes | UE context |
| Selection | value or a list of | | | |
| | values of S- | | | |
| | NSSAI(s). | | | |
| DNN | Either a single | Optional | Yes | UE context |
| Selection | value or a list of | | | |
| | values of | | | |
| | DNN(s). | | | |
| PDU Session | One single | Optional | Yes | UE context |
| Type Selection | value of PDU | | | |
| | Session Type | | | |
| Non-Seamless | Indicates if the | Optional | Yes | UE context |
| Offload | traffic of the | | | |
| indication | matching | | | |
| | application is to | | | |
| | be offloaded to | | | |
| | non-3GPP | | | |
| | access outside | | | |
| | of a PDU | | | |
| | Session. | | | |
| Access Type | Indicates the | Optional | Yes | UE context |
| preference | preferred | | | |
| | Access Type | | | |
| | (3GPP or non- | | | |
| | 3GPP or Multi- | | | |
| | Access) when | | | |
| | the UE | | | |
| | establishes a | | | |
| | PDU Session | | | |
| | for the | | | |
| | matching | | | |
| | application. | | | |
| Route | This part | Optional | | |
| Selection | defines the | | | |
| Validation | Route | | | |
| Criteria | Validation | | | |
| | Criteria | | | |
| | components | | | |
| Time Window | The time | Optional | Yes | UE context |
| | window when | | | |
| | the matching | | | |
| | traffic is | | | |
| | allowed. The | | | |
| | RSD is not | | | |
| | considered to | | | |
| | be valid if the | | | |
| | current time is | | | |
| | not in the time | | | |
| | window. | | | |
| Location | The UE | Optional | Yes | UE context |
| Criteria | location where | | | |
| | the matching | | | |
| | traffic is | | | |
| | allowed. The | | | |
| | RSD rule is not | | | |
| | considered to | | | |
| | be valid if the | | | |
| | UE location | | | |
| | does not match | | | |
| | the location | | | |
| | criteria. | | | |
| New | New | Mandatory | Yes | UE context |
| Information | Information | | | |
| | can be one of | | | |
| | PLMN-ID or | | | |
| | MCC(mobile | | | |
| | country code) | | | |
| | or RAT or | | | |
| | N3GPPA | | | |
| | Trusted/Untrusted | | | |

Referring to the table 4, the proposed method introduces new information in the route validation criteria block of the URSP rule configuration based on which PDU session will be decided to be routed to either 3GPPA/N3GPPA per PLMN. The new information can be one of PLMN id or MCC (Mobile Country Code) or Radio access technology (RAT) or N3GPP access (Trusted/Untrusted).

This new information will enable the UE (100) to decide which URSP rule to prioritise, if the UE (100) is connected across different PLMNs per access types or different RATs or inside a location (e.g. MCC). When this new information is configured the Route selection descriptor (RSD) selection criteria is satisfied only if the UE (100) is registered on respective PLMN ID (or if the UE has selected the respective PLMN ID/SNPN ID during PLMN selection procedure) or the UE (100) is in respective configured country (represented by mobile country code) or Radio access technology (RAT) or based on available trusted/untrusted non 3GPP access type.

Each URSP rule contains a Traffic descriptor (containing one or more components) that determines when the rule is applicable. The URSP rule is determined to be applicable when every component in the Traffic descriptor matches the corresponding information from the application or from the modem layer. The URSP rule is determined not to be applicable when for any given component in the Traffic descriptor. No corresponding information from the application/modem is available or the corresponding information from the application/modem does not match any of the values in the Traffic descriptor component.

If the URSP rule is provided that contains the Traffic descriptor with two or more components, it is recommended to also provide URSP rule(s) with lower precedence and a Traffic descriptor with less components, in order to increase the likelihood of URSP rule matching for a particular application Each URSP rule contains a list of Route Selection Descriptors containing one or multiple Route Selection Descriptors each having a different Route Selection Descriptor Precedence value. The Route Selection Descriptor contains one or more of the following components:

Session and Service Continuity (SSC) Mode: Indicates that the traffic of the matching application shall be routed via a PDU Session supporting the included a SSC Mode.

Network Slice Selection: Indicates that the traffic of the matching application shall be routed via a PDU Session supporting any of the included S-NSSAIs. It includes one or more S-NSSAI(s).

DNN Selection: Indicates that the traffic of the matching application shall be routed via a PDU Session supporting any of the included DNNs. It includes one or more DNN(s). When DNN is used in Traffic descriptor, corresponding Route Selection Descriptor of the rule shall not include DNN Selection component.

PDU Session Type Selection: Indicates that the traffic of matching application shall be routed via a PDU Session supporting the included PDU Session Type. The possible PDU Session Types are defined in clause 5.6.10 in TS 23.501.

Non-Seamless Offload indication: Indicates that traffic of the matching application is to be offloaded to non-3GPP access outside of a PDU Session when the rule is applied. If this component is present in a Route Selection Descriptor, no other components shall be included in the Route Selection Descriptor.

Access Type Preference: If the UE (100) needs to establish a PDU Session when the rule is applied, this indicates the Access Type (3GPP or non-3GPP or multi-access) on which the PDU Session should be established. The type “Multi-Access” indicates that the PDU Session should be established as a MA PDU Session, using both 3GPP access and non-3GPP access.

Time Window: The Route Selection Descriptor is not be considered valid unless the UE (100) is in the time window.

Location Criteria: The Route Selection Descriptor is not being considered valid unless the UE's location matches the Location Criteria.

PLMN ID: If the UE (100) needs to establish a PDU Session when the rule is applied, this is the PLMN on which the UE (100) is allowed to initiate the PDU session establishment.

MCC: If the UE (100) needs to establish a PDU Session when the rule is applied, this is the country code (i.e. the country in which UE resides) on which the UE (100) is allowed to initiate the PDU session establishment based on this route descriptor.

RAT: If the UE (100) needs to establish a PDU Session when the rule is applied, this is the Radio access technology (RAT) on which UE (100) is allowed to initiate the PDU session establishment based on this route descriptor.

Trusted/Untrusted access type: If the UE (100) needs to establish a PDU Session when the rule is applied, this is the trusted or untrusted non 3GPP access type on which UE (100) is allowed to initiate the PDU session establishment based on this route descriptor.

The term slice can be interpreted as either a single value or a list of values of S-NSSAI(s)).

The URSP rule with the “match all” Traffic descriptor is used to route the traffic of applications which do not match any other URSP rules and shall therefore be evaluated as the last URSP rule, i.e. with lowest priority. There shall be only one Route Selection Descriptor in this URSP rule. The Route Selection Descriptor in this URSP rule includes at most one value for each Route Selection Component.

For every newly detected application the UE (100) evaluates the URSP rules and determines if the URSP rules are applicable based on the route selection criteria and then for the detected application the UE (100) evaluates the URSP rules in the order of Rule Precedence and determines if the application is matching the Traffic descriptor which also contains the route selection criteria of any URSP rule. When the URSP rule is determined to be applicable for a given application, the UE (100) shall select a Route Selection Descriptor within this URSP rule in the order of the Route Selection Descriptor Precedence.

When a valid Route Selection Descriptor is found, the UE (100) determines if there is an existing PDU Session that matches all components in the selected Route Selection Descriptor which also includes the route selection criteria. The route selection descriptor is only valid if the respective route validation criteria is also satisfied and this also consists of route selection criteria. The UE (100) compares the components of the selected Route Selection Descriptor with the existing PDU Session(s) as follows:

For a component which only contains one value (e.g. SSC mode), the value of the PDU Session has to be identical to the value specified in the Route Selection Descriptor.

For a component which contains a list of values (e.g. Network Slice Selection), the value of the PDU Session has to be identical to one of the values specified in the Route Selection Descriptor.

When some component(s) is not present in the Route Selection Descriptor, a PDU Session is considered matching only if it was established without including the missing component(s) in the PDU Session Establishment Request.

When the Route Selection Descriptor includes a Time Window or a Location Criteria, the PDU Session is considered matching only if the PDU Session is associated with an RSD that has the same Time Window or a Location Criteria Validity Conditions.

When a matching PDU Session exists the UE (100) associates the application to the existing PDU Session, i.e. route the traffic of the detected application on this PDU Session. If the UE (100) determines that there is more than one existing PDU Session which matches (e.g. the selected Route Selection Descriptor only specifies the Network Slice Selection, while there are multiple existing PDU Sessions matching the Network Slice Selection with different DNNs), it is up to UE implementation to select one of them to use.

If none of the existing PDU Sessions matches, the UE (100) tries to establish the new PDU Session using the values specified by the selected Route Selection Descriptor. If the PDU Session Establishment Request is accepted, the UE (100) associates the application to this new PDU Session. If the PDU Session Establishment Request is rejected, based on the rejection cause, the UE (100) selects another combination of values in the currently selected Route Selection Descriptor if any other value for the rejected component in the same Route Selection Description can be used.

Otherwise, the UE (100) selects the next Route Selection Descriptor, which contains a combination of component value which is not rejected by network, in the order of the Route Selection Descriptor Precedence, if any. If the UE (100) fails to establish the PDU Session with any of the Route Selection Descriptors, it tries other URSP rules in the order of Rule Precedence with matching Traffic descriptors, except the URSP rule with the “match-all” Traffic descriptor, if any.

In yet another embodiment, the URSP configuration instead of having two different rules can contain two PLMN_IDs in a single rule. I.e. PLMN-1+3GPPA and PLMN-2+N3GPPA in a single rule. I.e. in this embodiment instead of just specifying a PLMN ID, two or more PLMN IDs can be specified and the combination is taken into account while evaluating the conditions to select a URSP, Traffic descriptor or route selection descriptor as described in this embodiment.

For example, the UE (100) can be configured with following URSP configuration is:

Rule precedence-1: PLMN-ID: PLMN_ID-1, DNN-1, Slice-ID-1, Access type: N3GPPA.

Rule precedence-2: PLMN-ID: PLMN_ID-2, DNN-1, Slice-ID-1, Access type: 3GPPA.

Rule precedence-3: PLMN-ID: PLMN_ID-1, DNN-1, Slice-ID-1, Access type: 3GPPA.

Rule precedence-4: PLMN-ID: PLMN_ID-2, DNN-1, Slice-ID-1, Access type: N3GPPA.

For above configuration,

DNN-1 is established over N3GPPA if PLMN_ID-1 is registered over N3GPPA.

If PLMN_ID-1 is not registered over N3GPPA and if PLMN_ID-2 is registered over 3GPPA then UE establishes DNN-1 over 3GPPA.

If PLMN_ID-1 is not registered over N3GPPA, PLMN_ID-2 is not registered over 3GPPA and PLMN_ID-1 is registered over 3GPPA then DNN-1 is established over 3GPPA.

If PLMN_ID-1 is not registered over N3GPPA and 3GPPA, PLMN_ID-2 is not registered over 3GPPA and PLMN_ID-2 is registered over N3GPPA then DNN-1 is established over N3GPPA.

In other words, the UE (100) can be configured with a given one or more new information as described in this embodiment for example PLMN_IDs in the UE (ME or USIM) configuration (for example URSP) based on which UE will select the appropriate traffic descriptor or route selection descriptor or PDU session (i.e. DNN)/Slice ID (Either a single value or a list of values of S-NSSAI(s)/SSC Type/PDU session type/Access type preference.

The above selection is based on whether the UE (100) is configured with this new information and the new information condition is satisfied only if the UE (100) is registered on respective PLMN ID or PLMN_IDs (as configured) or the UE (100) is in respective configured country (represented by mobile country code) or UE is on the respective Radio access technology (RAT) or based on available trusted/untrusted non 3GPP access type UE is using service/registered to.

In this embodiment, the PLMN ID is used as an example to represent a particular network in the new information, it can be SNPN(Standalone Non-Public Network) ID too or any other ID which represents a network like hosting network etc.

In this embodiment, each of the block consists of URSP information block, a traffic descriptor block, a route selection descriptor block and route validation criteria block in the URSP rule configuration of the UE (100). Each of this block consists of the route selection criteria comprise one of a PLMN identifier (ID), a Mobile Country Code (MCC), a Radio Access Technology (RAT) identifier and a Non-3rd Generation Partnership Project (Non-3GPP) access trusted or non-3GPP access untrusted.

When the URSP information block consists of one or more parameters of the route selection criteria only if the configured criteria is met those particular URSP rules are allowed to be selected by the UE (100).

When a traffic descriptor block consists of one or more parameters of the route selection criteria only if the configured criteria is met those particular Traffic descriptors are allowed to be selected by the UE (100).

When the route selection descriptor block consists of one or more parameters of the route selection criteria only if the configured criteria is met those particular route selection descriptor are allowed to be selected by the UE (100).

When the route validation criteria block consists of one or more parameters of the route selection criteria only if the configured criteria is met those particular route selection descriptor are allowed to be selected by the UE (100).

The route selection criteria is met when:

PLMN ID/SNPN ID is configured: If the UE (100) is registered on that respective PLMN ID or SNPN ID—or—if the UE has selected/camped on that PLMN ID or the SNPN ID during PLMN selection procedure.

Mobile Country Code (MCC): The UE (100) is in the respective country represented by the MCC. It can be single MCC or set of MCCs.

a Radio Access Technology (RAT) identifier: If the UE (100) is registered on the respective RAT like EPS, NG-RAN, 4G, 5G, 6G or like so.

Non-3GPP access—Trusted: If non-3GPP access trusted access is available or the UE (100) is registered or camped on the trusted non-3GPP access.

Non-3GPP access—Untrusted: If non-3GPP access untrusted access is available or the UE is registered or camped on the untrusted non-3GPP access.

The route selection criteria parameters above can be configured in any combination. i.e. those can be configured with And—or—or condition between them to get the end result. For example:

PLMN-ID: XX and Country: MM then UE is expected to select RSD-1.

PLMN-ID: XX or Country: MM then UE is expected to select RSD-2.

PLMN-ID: XX then UE is expected to select RSD-3.

FIG. 2b shows various hardware components of the UE (100), according to embodiments as disclosed herein. In an embodiment, the UE (100) includes a processor (110), a communicator (120), a memory (130), and a service initiation controller (140). The processor (110) is coupled with the communicator (120), the memory (130) and the service initiation controller (140). Additionally, the processor (110) may perform an operation of the service initiation controller (140).

The service initiation controller (140) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The service initiation controller (140) receives the URSP rule configuration from the HPLMN apparatus (200) and detects the initiation of the application in the UE (100). Based on the detection, the service initiation controller (140) determines that the URSP rule configuration is applicable to the application. Further, the service initiation controller (140) determines the block matching the route selection criteria in the URSP rule configuration and selects the block based on the route selection criteria. Based on the selected block, the service initiation controller (140) selects the route selection descriptor

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

Although the FIG. 2b shows various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

FIG. 2c shows various hardware components of the HPLMN apparatus (200), according to embodiments as disclosed herein. In an embodiment, the HPLMN apparatus (200) includes a processor (210), a communicator (220), a memory (230), and a service initiation controller (240). The processor (210) is coupled with the communicator (220), the memory (230) and the service initiation controller (240). The service initiation controller (240) is physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. Additionally, the processor (210) may perform an operation of the service initiation controller (240).

The service initiation controller (240) creates the URSP rule configuration comprising the route selection descriptor in the block and sends the URSP rule configuration to the UE (100) in the wireless network (1000) for controlling the service initiation based on the route selection descriptor included in the URSP rule configuration.

Further, the processor (210) is configured to execute instructions stored in the memory (230) and to perform various processes. The communicator (220) is configured for communicating internally between internal hardware components and with external devices via one or more networks. The memory (230) also stores instructions to be executed by the processor (210). The memory (230) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (230) may, in some examples, be considered a non-transitory storage medium. The term “non-transitory” may indicate that the storage medium is not embodied in a carrier wave or a propagated signal. However, the term “non-transitory” should not be interpreted that the memory (230) is non-movable. In certain examples, a non-transitory storage medium may store data that can, over time, change (e.g., in Random Access Memory (RAM) or cache).

Although the FIG. 2c shows various hardware components of the HPLMN apparatus (200) but it is to be understood that other embodiments are not limited thereon. In other embodiments, the HPLMN apparatus (200) may include less or more number of components. Further, the labels or names of the components are used only for illustrative purpose and does not limit the scope of the invention. One or more components can be combined together to perform same or substantially similar function in the HPLMN apparatus (200).

FIG. 3 is a flow chart (S300) illustrating a method, implemented by the UE (100), for selecting the route selection descriptor in the wireless network (1000), according to the embodiments as disclosed herein. The operations (S302 to S312) are performed by the service initiation controller (140).

At S302, the method includes receiving the URSP rule configuration from the HPLMN apparatus (200) in the wireless network (1000). At S304, the method includes detecting the initiation of the application in the UE (100). At S306, the method includes determining that the URSP rule configuration is applicable to the application. At S308, the method includes determining the block matching the route selection criteria in the URSP rule configuration. At S310, the method includes selecting the block based on the route selection criteria. At S312, the method includes selecting the route selection descriptor based on the selected block.

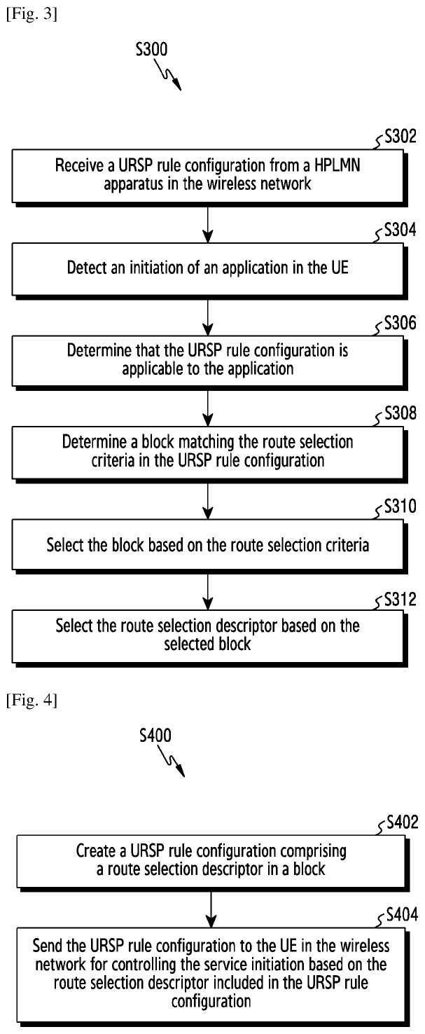

FIG. 4 is a flow chart (S400) illustrating a method, implemented by the HPLMN apparatus (200), for selecting the route selection descriptor in the wireless network (1000), according to the embodiments as disclosed herein. The operations (S402 and S404) are performed by the service initiation controller (240).

At S402, the method includes creating the URSP rule configuration comprising the route selection descriptor in the block. At S404, the method includes sending the URSP rule configuration to the UE (100) in the wireless network (1000) for controlling the service initiation based on the route selection descriptor included in the URSP rule configuration.

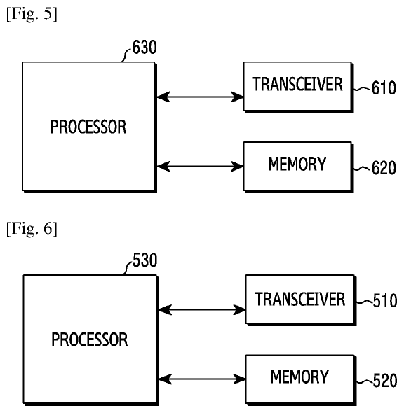

FIG. 5 is a block diagram of an internal configuration of a UE, according to an embodiment.

As shown in FIG. 5, the UE according to an embodiment may include a transceiver 510, a memory 520, and a processor 30. The transceiver 510, the memory 520, and the processor 530 of the UE may operate according to a communication method of the UE described above. However, the components of the UE are not limited thereto. For example, the UE may include more or fewer components than those described above. In addition, the processor 530, the transceiver 510, and the memory 520 may be implemented as a single chip. Also, the processor 530 may include at least one processor.

Furthermore, the UE of FIG. 5 corresponds to the UE of FIG. 2b.

The transceiver 510 collectively refers to a UE receiver and a UE transmitter, and may transmit/receive a signal to/from a base station or a network entity. The signal transmitted or received to or from the base station or a network entity may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor 530, a signal through a wireless channel, and transmit a signal output from the processor 530 through the wireless channel.

The memory 520 may store a program and data required for operations of the UE. Also, the memory 520 may store control information or data included in a signal obtained by the UE. The memory 520 may be a storage medium, such as read-only memory (ROM), random access memory (RAM), a hard disk, a CD-ROM, and a DVD, or a combination of storage media.

The processor 530 may control a series of processes such that the UE operates as described above. For example, the transceiver 510 may receive a data signal including a control signal transmitted by the base station or the network entity, and the processor 530 may determine a result of receiving the control signal and the data signal transmitted by the base station or the network entity.

FIG. 6 is a block diagram of an internal configuration of a base station or a network entity, according to an embodiment.

As shown in FIG. 6, the base station or the network entity according to an embodiment may include a transceiver 610, a memory 620, and a processor 630. The transceiver 610, the memory 620, and the processor 630 of the base station or the network entity may operate according to a communication method of the base station or the network entity described above. However, the components of the base station or the network entity are not limited thereto. For example, the base station or the network entity may include more or fewer components than those described above. In addition, the processor 630, the transceiver 610, and the memory 6320 may be implemented as a single chip. Also, the processor 630 may include at least one processor.

Furthermore, the network entity of the FIG. 6 corresponds to the HPLMN apparatus of FIG. 2C. The transceiver 610 collectively refers to the base station (or the network entity receiver) and a base station (or the network entity) transmitter, and may transmit/receive a signal to/from a terminal or a network entity or a base station. The signal transmitted or received to or from the terminal or a network entity or the base station may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the base station or the network entity. Also, the memory 620 may store control information or data included in a signal obtained by the base station or the network entity. The memory 620 may be a storage medium, such as read-only memory (ROM), random access memory (RAM), a hard disk, a CD-ROM, and a DVD, or a combination of storage media.

The processor 630 may control a series of processes such that the base station or the network entity operates as described above. For example, the transceiver 610 may receive a data signal including a control signal transmitted by the terminal or the network entity or the base station, and the processor 630 may determine a result of receiving the control signal and the data signal transmitted by the terminal or the network entity or the base station.

The various actions, acts, blocks, steps, or the like in the flow charts (S300 and S400) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-10. (canceled)

11. A method performed by a user equipment (UE), in a wireless communication system, the method comprising:
receiving, from home public land mobile network (HPLMN), a user equipment route selection policy (URSP) rule configuration including one or more URSP rules including a traffic descriptor (TD) and one or more route selection descriptor (RSD)s;
detecting an application for the UE;
evaluating the one or more URSP rules in an order of rule precedence;
identifying a URSP rule which includes a TD of the URSP rule matched with the detected application; and
in case that the URSP rule is identified to be applicable for the detected application, selecting a RSD included in the URSP rule.

12. The method of claim 11, further comprising:
identifying whether the URSP rule identified to be applicable for the detected application is used, based on a public land mobile network (PLMN) identity of a PLMN to which the UE is registered.

13. The method of claim 12, wherein the URSP rule is identified to be used in case that the URSP rule is associated with the identity of the PLMN to which the UE is registered.

14. The method of claim 11, further comprising:
in case that the RSD is selected, identifying an existing protocol data unit (PDU) session matched with all components in the selected RSD.

15. The method of claim 14, further comprising:
in case that the existing PDU session matched with the all components in the selected RSD is identified, associating the detected application to the identified existing PDU session.

16. The method of claim 15, further comprising:
in case that the existing PDU session matched with the all components in the selected RSD is not identified, establishing a PDU session using values specified based on the selected RSD.

17. The method of claim 11, wherein the RSD is selected in an order of RSD precedence.

18. A user equipment (UE) in a wireless communication system, the UE comprising:
a transceiver; and
a controller coupled with the transceiver and configured to:
receive, from home public land mobile network (HPLMN), a user equipment route selection policy (URSP) rule configuration including one or more URSP rules including a traffic descriptor (TD) and one or more route selection descriptor (RSD)s,
detect an application for the UE,
evaluate the one or more URSP rules in an order of rule precedence;
identify a URSP rule which includes a TD of the URSP rule matched with the detected application, and
in case that the URSP rule is identified to be applicable for the detected application, select a RSD included in the URSP rule.

19. The UE of claim 18, wherein the controller is further configured to:
identify whether the URSP rule identified to be applicable for the detected application is used, based on a public land mobile network (PLMN) identity of a PLMN to which the UE is registered.

20. The UE of claim 19, wherein the URSP rule is identified to be used in case that the URSP rule is associated with the identity of the PLMN to which the UE is registered.

21. The UE of claim 18, wherein the controller is further configured to:
in case that the RSD is selected, identifying an existing protocol data unit (PDU) session matched with all components in the selected RSD.

22. The UE of claim 21, further comprising:
in case that the existing PDU session matched with the all components in the selected RSD is identified, associating the detected application to the identified existing PDU session.

23. The UE of claim 22, further comprising:
in case that the existing PDU session matched with the all components in the selected RSD is not identified, establishing a PDU session using values specified based on the selected RSD.

24. The UE of claim 18, wherein the RSD is selected in an order of RSD precedence.
